(19) United States
(12) Patent Application Publication
(10) Pub. No.: US 2019/0276630 A1
(43) Pub. Date: Sep. 12, 2019

(54) POLYSILOXANE BASED AEROGELS

(71) Applicants: Henkel IP & Holding GmbH, Duesseldorf (DE); Henkel AG & Co. KGaA, Duesseldorf (DE)

(72) Inventors: Sergi Bassaganas Turon, Olot (ES); lzaskun Miguel Garcia, Alfaz del Pi Alicante (ES); Elisabet Torres Cano, Barcelona (ES); Fouad Salhi, Farmington, CT (US)

(21) Appl. No.: 16/222,135

(22) Filed: Dec. 17, 2018

Related U.S. Application Data
(63) Continuation of application No. PCT/EP2017/063969, filed on Jun. 8, 2017.

(30) Foreign Application Priority Data
Jun. 17, 2016 (EP) 16175010.4

(51) Int. Cl. C08J 9/28; C08G 77/458; C08J 9/00

(52) U.S. Cl. CPC C08J 9/286; C08G 2101/0091; C08J 9/0085; C08G 77/458

(57) ABSTRACT

The present invention relates polysiloxane based aerogels obtained by reacting a functionalised poly(dimethylsiloxane) oligomer and an aliphatic or aromatic isocyanate compound in a presence of a catalyst and a solvent. A polysiloxane based aerogels according to the present invention provide high thermal insulation material, while good mechanical properties and performance is maintained.

### Technical field

The present invention relates to polysiloxane based aerogels by reacting a functionalised poly(dimethylsiloxane) oligomer and an aliphatic or aromatic isocyanate compound in a presence of a solvent and a catalyst. The polysiloxane based aerogels according to the present invention provide high thermal insulation materials, while maintaining good mechanical properties.

### BACKGROUND OF THE INVENTION

Aerogels are three-dimensional, low-density solid network structures derived from drying wet-gels by exchanging the pore-filling solvent to a gas, usually with a supercritical fluid. By these means, the capillary forces exerted by the solvent due to evaporation are minimized, and structures with large internal void space on the nanometric range are achieved. The high porosity and the small pore size of these materials is the reason for their very low thermal conductivity, which makes aerogels extremely attractive materials for thermal insulating applications.

Thermal insulation is important in many different applications in order to save energy and reduce costs. Examples of such applications are construction, transport and industry. For some applications, it is possible to use a thick insulating panel to reduce the heat transfer. However, other applications may require thinner insulating panels and/or layers because of size limitations. For the thin insulating panels/layers the thermal conductivity of the material has to be extremely low in order to get the same insulating properties than with thicker insulating panels and/or layers.

Additionally, in some cases and depending on the application, high mechanical properties may also be required.

Compared to common thermal insulators in the market, aerogels are lightweight materials with a very low thermal conductivity due to their nanostructure and the reduction of the contribution to thermal conductivity from the gas phase. Thus, thickness of the insulating layer can be reduced while obtaining similar insulating properties.

Most of known aerogels are inorganic aerogels, which are mainly based on silica. Despite their high thermal insulating properties, a slow commercialization has been observed due to their fragility and poor mechanical properties. This fragility may be overcome by different methods. For example, by cross-linking aerogels with organic polymers or by post-gelation casting of a thin conformal polymer coating over the entire internal porous surface of the preformed wet-gel nanostructure. Moreover, inorganic aerogels are brittle, dusty and easy air-borne, and therefore, cannot withstand mechanical stress. Because of that, sometimes they are classified as hazardous materials. In addition, due to their brittleness, they are not suitable for some applications where mechanical properties are required.

On the other hand, different organic aerogels have also been described in the literature. These materials are generally based on polymeric networks of different nature, formed by cross-linking of monomers in a solution to yield a gel, which is subsequently dried to obtain a porous material. Organic aerogels are robust and mechanically stable, which is an advantage for many applications. However, some of these materials can also have drawbacks.

First organic aerogels described in the literature were based on phenol-formaldehyde resins, which can also be used to prepare carbon aerogels by pyrolysis. Resorcinol-formaldehyde aerogels are brittle and their curing process takes a long time (up to 5 days), which results a drawback for an industrial scale production. Other significant organic aerogels are based on materials prepared using polyfunctional isocyanates, which have faster curing processes, and their mechanical properties can be modified. Mechanical properties depend on the reacting functional group with the isocyanate moiety, as well as the monomer and/or oligomer chemical structure (i.e. number of functionalities, aromatic or aliphatic nature, steric hindrance, etc.). In addition, numerous aerogels made from biopolymers, such as cellulose are also reported in the literature. Although these materials are more durable and have better mechanical properties, they do not show high thermal insulating properties. Recently there have been approaches to use clays as a silica replacement, because they are an inexpensive silica source. Moreover, the large aspect ratio that comes from clays' unique morphology is responsible for the enhancement of many properties compared to conventional inorganic fillers, like barrier properties, flammability resistance, strengthen of mechanical properties in two directions, membrane properties and polymer blend compatibilization.

Therefore, there is still a need for further aerogels having improved thermal conductivity and mechanical properties.

### SUMMARY OF THE INVENTION

The present invention relates to a polysiloxane based aerogel obtained by reacting a functionalised poly(dimethylsiloxane) oligomer and an aliphatic or aromatic isocyanate compound in a presence of a catalyst and a solvent, wherein said functionalised poly(dimethylsiloxane) oligomer is selected from the group consisting of

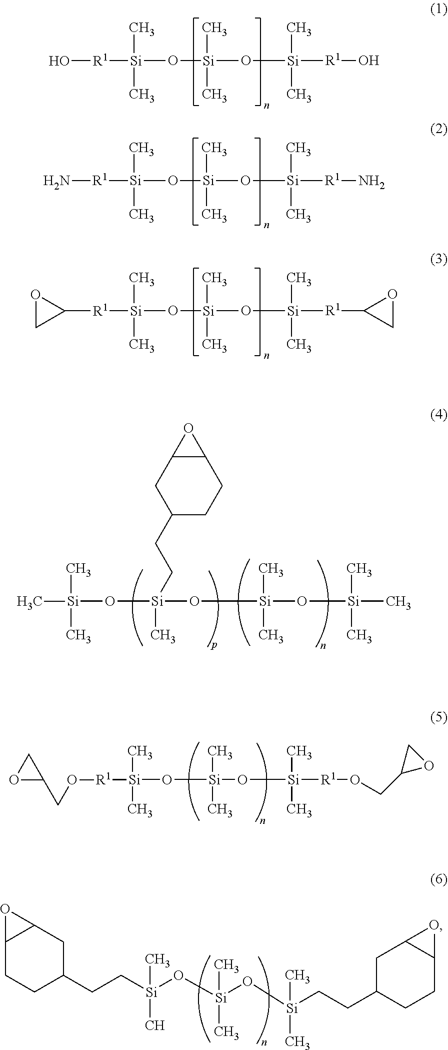

wherein R¹ is selected from the group consisting of CₘH₂ₘ alkyl or aryl group, where m is from 0 to 10, and n is an integer from 0 to 200, and p is an integer from 1 to 20.

The present invention also encompasses a process for preparing a polysiloxane based aerogel according the present invention comprising the steps of: 1) dissolving poly(dimethylsiloxane) oligomer and an isocyanate compound into a solvent and mixing; 2) adding a catalyst and mixing; 3) letting the mixture of step 2 stand to form a gel; 4) washing the gel of step 3 with a solvent; 5) drying the gel of step 4 by supercritical or ambient drying.

The present invention relates also to a thermal or an acoustic insulating material comprising a polysiloxane based aerogel according the present invention.

The present invention further relates to a use of a polysiloxane based aerogel according the present invention as a thermal or an acoustic insulating material.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical end points includes all numbers and fractions subsumed within the respective ranges, as well as the recited end points.

All percentages, parts, proportions and then like mentioned herein are based on weight unless otherwise indicated.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

All references cited in the present specification are hereby incorporated by reference in their entirety.

Unless otherwise defined, all terms used in disclosing the invention, including technical and scientific terms, have the meaning as commonly understood by one of the ordinary skill in the art to which this invention belongs to. By means of further guidance, term definitions are included to' better appreciate the teaching of the present invention.

The aim of the present invention is to obtain an aerogel material that overcomes the fragility of inorganic aerogels, while maintaining good thermal insulation properties. In order to achieve that, the applicant has found out that the reaction of alcohol, amino and/or epoxy-functionalized poly (dimethylsiloxane) (PDMS) oligomers and multi-functional isocyanate monomers will provide an aerogel with good thermal and mechanical properties.

A polysiloxane based aerogels according to the present invention are obtained by reacting a functionalised poly(dimethylsiloxane) oligomer and an aliphatic or aromatic isocyanate compound in a presence of a catalyst and a solvent. The reaction takes place between the terminal groups of the PDMS oligomers and the isocyanate moieties. The final chemical structure of the aerogel obtained depends on the nature of the functional group of the PDMS oligomer.

A suitable poly (dimethylsiloxane) oligomer for use in the present invention is a compound, having a functionality of 2 or higher. Suitable poly (dimethylsiloxane) oligomer can be functionalized with a variety of chemical compounds, such as amino, hydroxyl or epoxy groups. In the case of a hydroxyl-PDMS or an epoxy-PDMS is used in the reaction, a polyurethane-polysiloxane material is obtained. Whereas the PDMS-NH₂ precursor produces a polyurea-polysiloxane material. Scheme 1 below illustrates the chemical reactions involved in each case with a di-functional isocyanate.

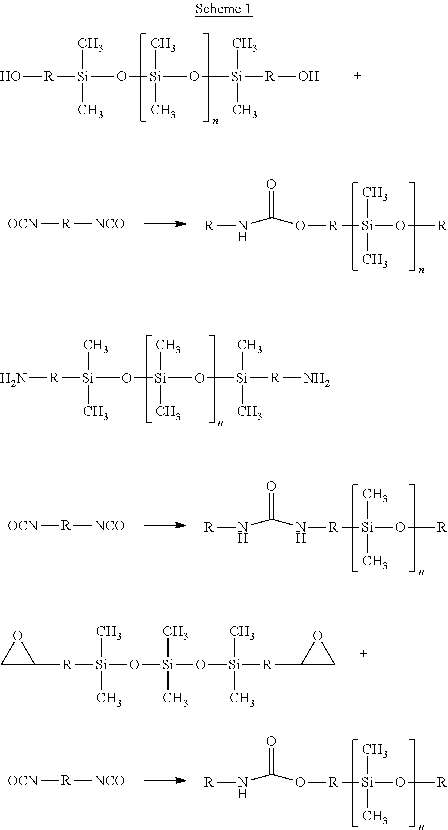

Functionalised poly(dimethylsiloxane) oligomers with different molecular weights can be used in order to obtain aerogels with different properties. PDMS-OH, PDMS-NH₂ and PDMS-epoxy oligomers with molecular weight as low as ˜300-500 g/mol have been successfully used to form an aerogel according to the present invention. On the other hand, the upper limit for the molecular weight is about 12000 g/mol, preferably about 6000 g/mol for the PDMS-OH, PDMS-NH₂ and PDMS-epoxy oligomers, more preferably about 3000 g/mol, and even more preferably about 2000 g/mol.

Suitable functionalised poly(dimethylsiloxane) oligomer for use in the present invention is selected from the group consisting of

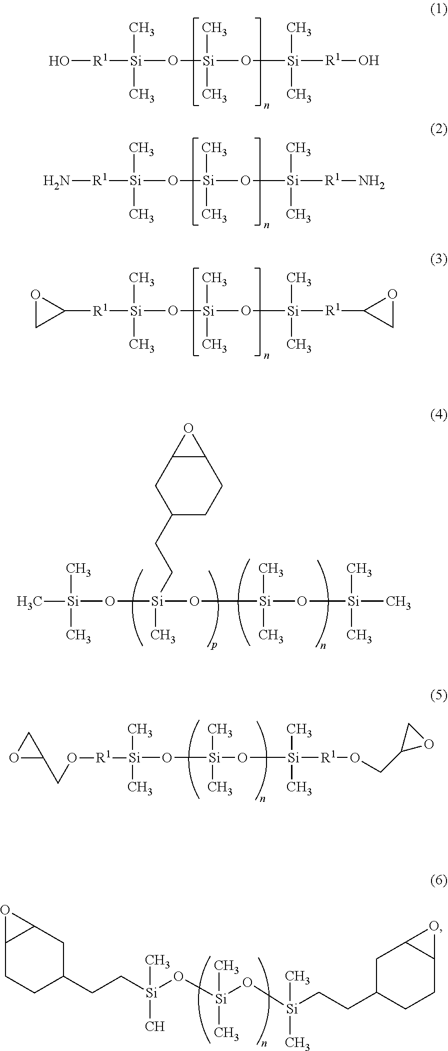

wherein R¹ is selected from the group consisting of CₘH₂ₘ alkyl or aryl group, wherein m is from 0 to 10, and n is an integer from 0 to 200, and p is an integer from 1 to 20.

In one embodiment R¹ is selected from the group consisting of CₘH₂ₘ alkyl or aryl group, wherein m is from 0 to 10, and n is an integer from 0 to 100.

In yet another embodiment, R¹ is selected from the group consisting of CₘH₂ₘ m alkyl or aryl group, wherein m is from 1 to 10, and n is an integer from 1 to 100, and p is an integer from 1 to 10.

Preferably, said functionalised poly(dimethylsiloxane) oligomer is selected from the group consisting of silanol terminated polydimethylsiloxanes, aminopropyl terminated polydimethylsiloxanes, N-ethylaminoisobutyl terminated polydimethylsiloxane, epoxypropoxypropyl terminated polydimethylsiloxanes, (epoxypropoxypropyl)dimethoxysilyl terminated polydimethylsiloxanes, epoxycyclohexylethyl terminated polydimethylsiloxanes, carbinol (hydroxyl) terminated polydimethylsiloxanes and mixtures thereof.

These PDMS oligomers are preferred because they can be obtained with different molecular weights within the preferred molecular weight range.

Examples of commercially available functionalised poly(dimethylsiloxane) oligomer for use in the present invention are but not limited to FLUID NH 15 D, FLUID NH 40 D, FLUID NH 130 D, FLUID NH 200 D and IM 11 from WACKER®, poly(dimethylsiloxane) diglycidyl ether terminated, poly(dimethylsiloxane) hydroxy terminated, poly(dimethylsiloxane) bis(hydroxyalkyl) terminated and poly(dimethylsiloxane) bis(3-aminopropyl) terminated from Sigma-Aldrich and silanol terminated polydimethylsiloxanes, aminopropyl terminated polydimethylsiloxanes, N-ethylaminoisobutyl terminated polydimethylsiloxane, epoxypropoxypropyl terminated polydimethylsiloxanes, (epoxypropoxypropyl)dimethoxysilyl terminated polydimethylsiloxanes, epoxycyclohexylethyl terminated polydimethylsiloxanes and carbinol (hydroxyl) terminated polydimethylsiloxanes from Gelest, Inc.

A polysiloxane based aerogel according to the present invention has a functionalised poly(dimethylsiloxane) oligomer content from 1 to 40% by weight of the initial solution weight, preferably from 2 to 30% and more preferably from 3 to 25%.

If the content of the functionalised poly(dimethylsiloxane) oligomer is more than 40%, aerogels with high density and high thermal conductivity will be obtained. These are not desired properties for the aerogels according to the present invention.

A polysiloxane based aerogel according to the present invention is obtained by reacting a functionalised poly(dimethylsiloxane) oligomer and an aliphatic or aromatic isocyanate compound. A suitable isocyanate compound for use in the present invention is an aliphatic or aromatic isocyanate compound having a functionality from 2 to 6.

A suitable aliphatic or aromatic isocyanate compound for use in the present invention is selected from the group consisting of

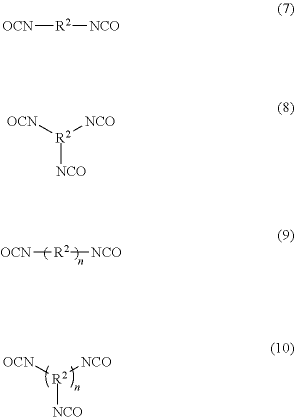

wherein R² is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof; and n is an integer from 1 to 30;

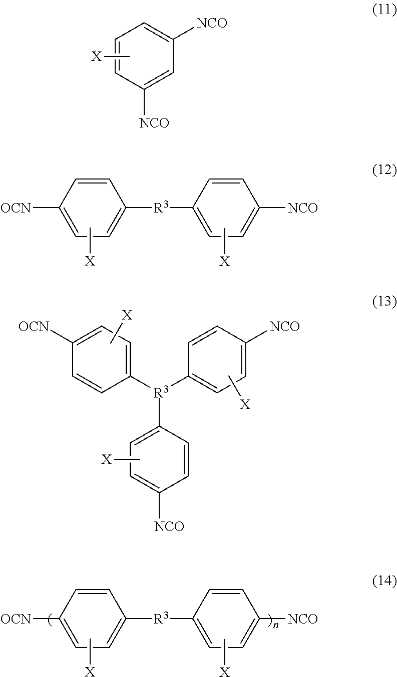

wherein X represents a substituent, or different substituents and are selected independently from the group consisting of hydrogen, halogen and linear or branched C1-C6 alkyl groups, attached on their respective phenyl ring at the 2-position, 3-position or 4-position, and their respective isomers, and R³ is selected from the group consisting of a single bonded —O—, —S—, —O(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3 to C30 heterocycloalkyl group and a substituted or unsubstituted C1-C30 heteroalkyl group from and a combination of thereof; and n is an integer from 1 to 30;

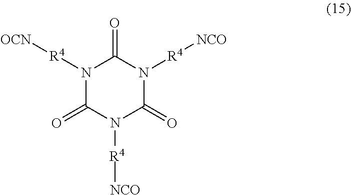

wherein R⁴ is alkyl group having 1-10 carbon atoms;

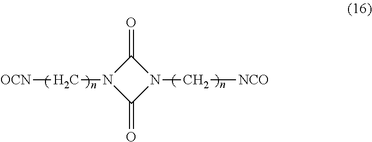

wherein n is an integer having a value from 2 to 18;

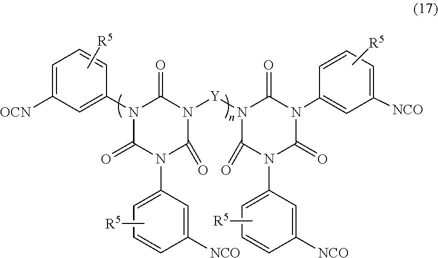

wherein R⁵ is selected independently from the group consisting of alkyl, hydrogen and alkenyl, and Y is selected from the group consisting of

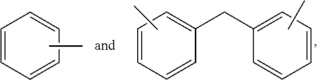

and n is an integer from 0 to 3;

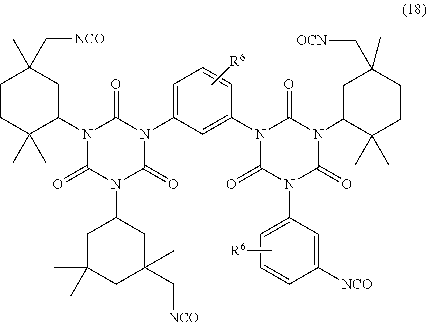

wherein R⁶ is selected independently from the group consisting of alkyl, hydrogen and alkenyl.

Preferably, isocyanate compound is selected from the group consisting of 1,3,5-tris(6-isocyanatohexyl)-1,3,5-triazinane-2,4,6-trione, 6-[3-(6-isocyanatohexyl)-2,4-dioxo-1,3-diazetidin-1-yl]hexyl N-(6-isocyanatohexyl)carbamate, methylene diphenyl diisocyanate (MDI), 1-[bis(4-isocyanatophenyl)methyl]-4-isocyanatobenzene, 2,4-diisocyanato-1-methyl-benzene, oligomers of 1,3,5-tris(6-isocyanatohexyl)-1,3,5-triazinane-2,4,6-trione, oligomers of 6-[3-(6-isocyanatohexyl)-2,4-dioxo-1,3-diazetidin-1-yl]hexyl N-(6-isocyanatohexyl)carbamate, oligomers of methylene diphenyl diisocyanate (MDI), oligomers of 1-[bis(4-isocyanatophenyl)methyl]-4-isocyanatobenzene, oligomers of 2,4-diisocyanato-1-methyl-benzene and mixtures thereof.

Preferred isocyanates provide a high crosslinking degree, fast gelling times, gelation at ambient conditions and homogeneous materials. Suitable commercially available isocyanates for use in the present invention include, but are not limited to Desmodur N3300, Desmodur N3200, Desmodur RE, Desmodur HL, Desmodur IL available from Bayer; Polurene KC and Polurene HR from Sapici, methylene diphenyl diisocyanate (MDI), toluylene diisocyanate (TDI) and hexamethylene diisocyanate (HDI) from Sigma Aldrich.

A polysiloxane based aerogel according to the present invention has an isocyanate compound content from 0.5 to 30% by weight of the initial solution weight, preferably from 0.5 to 20% and more preferably from 0.5 to 10%.

If the content of the isocyanate compound is more than 30%, aerogels with high density and high thermal conductivity will be obtained. These are not desired properties for the aerogels according to the present invention.

A polysiloxane based aerogel according to the present invention has a solid content from 2.5 to 50% by weight of the initial solution weight, preferably from 3 to 30% and more preferably from 5 to 15%.

Preferred solid content provides aerogels having an ideal compromise between thermal conductivity and mechanical properties. A polysiloxane based aerogel according to present invention has a functionalised poly(dimethylsiloxane) oligomer and an aliphatic or aromatic isocyanate compound equivalent ratio, NCO/OH≥0.5, preferably NCO/OH≥1 when hydroxyl functionalised poly(dimethylsiloxane) oligomer is used, and NCO/NH₂≥1, when amino functionalised poly(dimethylsiloxane) oligomer is used, and NCO/epoxy≥0.3, preferably NCO/epoxy from 3:1 to 1:3 when epoxy functionalised poly(dimethylsiloxane) oligomer is used.

These ratios are preferred because when PDMS-OH and PDMS-NH₂ are used, a higher ratio of isocyanate leads to a higher cross-linking degree. PDMS-epoxy, on the other hand, has a more versatile chemistry, and therefore, broader ranges provide materials with a higher variety of desired properties.

A polysiloxane based aerogel according to the present invention is obtained by reacting a functionalised poly(dimethylsiloxane) oligomer and an aliphatic or aromatic isocyanate compound in a presence of a solvent.

A suitable solvent for use in the present invention is a polar aprotic or non-polar solvent. Preferably, the solvent is a polar aprotic solvent. More preferably, the solvent is selected from the group consisting of acetone, dimethylsulfoxide, dimethylformamide, dimethylacetamide, N-methyl-2-pyrrolidone, 1,4-dioxane, acetonitrile, methyl ethyl ketone, methyl isobutyl ketone, toluene and mixtures thereof.

Functionalised poly(dimethylsiloxane) oligomer, isocyanate and optional ingredient quantities depend on the initial solvent quantity. As an example, in order to form a polysiloxane based aerogel according to the present invention, from batch of 1 L of solvent (acetone) 7.8-316 g of poly(dimethylsiloxane) oligomer (1-40 wt %) and 3.9-237g of isocyanate (0.5-30 wt %) is required.

A polysiloxane based aerogel according to the present invention is obtained by reacting a functionalised poly(dimethylsiloxane) oligomer and an aliphatic or aromatic isocyanate compound in a presence of a catalyst.

A suitable catalyst for use in the present invention is selected from the group consisting of alkyl amines, aromatic amines, imidazole derivatives, tin derivatives, aza compounds, guanidine derivatives, amidines and mixtures thereof.

Preferably, the catalyst is selected from the group consisting of triethylamine, trimethylamine, benzyldimethylamine (DMBA), N,N-dimethyl-1-phenylmethanamine, 1,4-diazabicyclo[2.2.2]octane, 2-ethyl-4-methylimidazole, 2-phenylimidazole, 2-methylimidazole, 1-methylimidazole, 4,4′-methylene-bis(2-ethyl-5-methylimidazole), 3,4,6,7,8,9-hexahydro-2H-pyrimido[1,2-a]pyrimidine, 2,3,4,6,7,8,9,10-octahydropyrimido [1,2-a]azepine, 1,8-diazabicyclo[5.4.0]undec-7-ene (DBU), 1,5,7-triazabicyclo[4.4.0]dec-5-ene (TBD), 1,4-diazabicyclo[2.2.2]octane, 1,5-diazabicyclo[4.3.0]non-5-ene, quinuclidine, dibutyltin dilaurate (DBTDL) and mixtures thereof.

A polysiloxane based aerogel according to the present invention has a catalyst content from 0.01 to 30% by weight of the weight of the starting monomers, preferably from 1 to 25%, and more preferably from 5 to 20%.

A polysiloxane based aerogel according to the present invention may further comprise at least one reinforcement, wherein said reinforcement is selected from the group consisting of fibres, particles, non-woven and woven fibre fabrics, 3D structures and mixtures thereof.

Examples of suitable fibres are cellulose fibres, aramid, carbon, glass and lignocellulosic fibres.

Examples of suitable particles are carbon black, microcrystalline cellulose, silica, cork, lignin, and aerogel particles.

Examples of suitable fibre fabrics are non-woven and woven glass, aramid, carbon and lignocellulosic fibre fabrics.

Examples of suitable 3D structures are aramid fibre-phenolic honeycomb, glass fibre-phenolic honeycomb, polycarbonate core and polypropylene core.

In a preferred embodiment at least one reinforcement is selected from the group consisting of cellulose fibres, aramid fibres, carbon fibres, glass fibres, lignocellulosic fibres, carbon black, microcrystalline cellulose, silica particles, cork particles, lignin particles, aerogel particles, non-woven and woven glass fibre fabrics, aramid fibre fabrics, carbon fibre fabrics, jute fibre fabrics, flax fibre fabrics, aramid fibre-phenolic honeycomb, glass fibre-phenolic honeycomb, polycarbonate core, polypropylene core, and mixtures thereof, more preferably at least one reinforcement is selected from the group consisting of cellulose fibres, aramid fibres, carbon fibres, glass fibres, carbon black, microcrystalline cellulose, non-woven glass fibre fabrics, woven aramid fibre fabrics, woven jute fibre fabrics, woven flax fibre fabrics, aramid fibre-phenolic honeycomb, glass fibre-phenolic honeycomb and mixtures thereof.

Examples of commercially available reinforcements for use in the present invention are but not limited to Acros Organics microcrystalline cellulose, Evonic Printex II carbon black, a-cellulose Sigma Aldrich powder, Procotex aramid fibre, Procotex CF-MLD100-13010 carbon fibres, E-glass Vetrotex textiles fibres EC9 134 z28 T6M ECG 37 1/0 0.7z, Unfilo® U809 Advantex® glass fiber, Composites Evolution Biotex jute plain weave, Composites Evolution Biotex flax 2/2 twill, Easycomposites Aramid Cloth Fabric Satin Weave, Euro composites ECG glass fibre-phenolic honeycomb, Euro composites ECAI aramid fibre-phenolic honeycomb, Cel Components Alveolar PP8-80T30 3D structure, Cel Components Alveolar 3.5-90 3D structure.

Depending of the reinforcement incorporated into the polysiloxane based aerogel according to the present invention, the reinforcement percentage in the final material may vary from 0.01% up to 30% based on the total weight of the initial solvent.

In one embodiment, a particle reinforcement such as carbon black is used and the amount added into the polysiloxane based aerogel is less than 0.1% based on the initial solvent weight.

In another embodiment, glass fibre fabrics are included in the polysiloxane based aerogel, and the amount added to the polysiloxane based aerogel is up to 30% based on the initial solvent weight.

In another embodiment, a 3D structure such as an aramid fibre/phenolic resin honeycomb is incorporated into the polysiloxane based aerogel as a reinforcement. The amount is around 4% based on the initial solvent weight.

Structural reinforcement has been successfully performed for the polysiloxane based aerogels according to the present invention, obtaining an improvement in mechanical properties of approximately 600 times. This has led to honeycomb reinforced polysiloxane based aerogels having Young modulus up to 60 MPa.

A polysiloxane based aerogel according to the present invention has a thermal conductivity less than 60 mW/m·K, preferably less than 50 mW/m·K, more preferably less than 45 mW/m·K measured by C-Therm TCi means as described below.

Thermal conductivity can be measured by using diffusivity sensor method as described below.

Diffusivity sensor method—In this method, the thermal conductivity is measured by using a diffusivity sensor. In this method, the heat source and the measuring sensor are on the same side of the device. The sensors measure the heat that diffuses from the sensor throughout the materials. This method is appropriate for lab scale tests.

A polysiloxane based aerogel according to the present invention has a compression Young's modulus more than 0.1 MPa, preferably more than 15 MPa, and more preferably more than 30 MPa, wherein Compression Young Modulus is measured according to the method ASTM D1621.

A polysiloxane based aerogel according to the present invention has preferably a compressive strength more than 0.01 MPa, more preferably more than 0.45 MPa, and even more preferably more than 3 MPa. Compressive strength is measured according to the standard ASTM D1621.

A polysiloxane based aerogel according to the present invention has preferably a specific surface area ranging from 10 m²/g to 300 m²/g. Surface area is determined from N2 sorption analysis at —196° C. using the Brunauer-Emmett-Teller (BET) method, in a specific surface analyser Quantachrome-6B. High surface area values are preferred because they are indicative of small pore sizes, and which may be an indication of low thermal conductivity values.

A polysiloxane based aerogel according to the present invention has preferably an average pore size ranging from 5 to 80 nm. Pore size distribution is calculated from Barret-Joyner-Halenda (BJH) model applied to the desorption branch from the isotherms measured by N₂ sorption analysis. Average pore size was determined by applying the following equation: Average pore size=(4*V/SA) wherein V is total pore volume and SA is surface area calculated from BJH. Porosity of the samples can also be evaluated by He picnometry.

Aerogel pore size below the mean free path of an air molecule (which is 70 nm) is desired, because that allows obtaining high performance thermal insulation aerogels having very low thermal conductivity values.

A polysiloxane based aerogel according to the present invention has low-density structure having a bulk density ranging from 0.01 to 0.8 g/cc. Bulk density is calculated from the weight of the dry aerogel and its volume.

The synthetic process used in the present invention enables the use of different reaction parameters, such as the isocyanate/PDMS equivalent ratio, solid content, solvent, catalyst, catalyst ratio, temperature or drying procedure. The versatility of the composition according to the present invention allows for the application of a wide variety of experimental parameters and conditions that lead to a successful gel formation. Such different gels, yield afterwards aerogels with adjustable performance in terms of mechanical and thermal properties.

A process for preparing a polysiloxane based aerogel according the present invention comprises the steps of:
1) dissolving poly(dimethylsiloxane) oligomer and an isocyanate compound into a solvent and mixing;
2) adding a catalyst and mixing;
3) letting the mixture of step 2 stand to form a gel;
4) washing the gel of step 3 with a solvent;
5) drying the gel of step 4 by supercritical or ambient drying.

The polymerization reaction yielding a gel occurs in in the first three steps. A gelling time in step 3 is from 1 hour to 24 hours, preferably from 1 hour to 12 hours.

A temperature from 20° C. to 100° C. is applied at step 3 to form a gel, preferably temperature from 20° C. to 75° C. is applied, and more preferably, temperature from 20° C. to 50° C. is applied.

Ageing time according to the present invention is from 10 minutes to 6 hours, preferably from 10 minutes to 2 hours. By the term “ageing time” is meant the time elapsed between the gel formation and the addition of a fresh solvent. This is the time left for the system to strengthen and consolidate its structure.

The washing step (4) involves a solvent exchange, wherein the initial solvent is replaced by a fresh solvent one or more times in order to remove the impurities.

A washing time is from 18 to 72 hours, preferably from 24 to 72 hours in step 4. By the term washing time is meant the time elapsed for the different solvent exchanges. Once the sample is aged, some fresh solvent is added into the system. This solvent is then exchanged every 24 hours for a new solvent, and the process may be done up to three times.

Once the wet gel remains in the proper solvent, it may be dried by ambient and/or supercritical (CO₂) drying (step 5). When the replacing solvent is acetone, the obtained gels are dried in CO₂, whereas if the replacing solvent is hexane, the obtained gels are dried at ambient conditions. In a drying step, the removal of the solvent is carried out in such a way that stresses in the solid backbone are minimized to yield a material that has a high porosity and a low density.

The main method for subcritical drying is ambient drying, where the appropriate solvent is allowed to dry under ambient conditions. Although this procedure is relatively inexpensive, it entails some problems. When the original solvent in the gel is evaporated, capillary stress in the pores of the gel induces the struts of the pore network to collapse and the material shrinks. The density of the aerogel is increased and consequently a less insulating material is obtained. The most effective method, supercritical drying, overcomes these problems. The process takes advantage of removing the initial solvent by using a supercritical fluid. By these means, the capillary forces exerted by the solvent due to evaporation are minimized, and structures with large internal void spaces are achieved.

In one embodiment, the method for preparing the polysiloxane based aerogel involves the recycling of the CO2 from the supercritical drying step.

A polysiloxane based aerogel according to the present invention may be dried by both procedures, ambient and supercritical drying. This feature can present a benefit, since allows the drying technique to be selected according to the application requirements.

Very limited shrinkage of the final aerogel structure (compared to the initial volume of the wet gel) is obtained for the aerogels according to the present invention. The shrinkage has been found to be ˜7% for the samples dried by supercritical drying and 15-20% for the samples dried at ambient conditions. Compared to the results found in the literature for other formulations, the shrinkage the functionalised PDMS based aerogels according to the present invention is lower by both drying techniques. The present invention also relates to a thermal or an acoustic insulating material comprising a polysiloxane based aerogel according to the present invention.

A polysiloxane based aerogel according any to the present invention may be used as a thermal or an acoustic insulating material.

Polysiloxane based aerogels according to the present invention can be used for thermal insulation in different applications such as aircrafts, space crafts, pipelines, tankers and maritime ships replacing currently used foam panels and other foam products, in car battery housings and under hood liners, lamps, in cold packaging technology including tanks and boxes, jackets and footwear and tents.

Polysiloxane based aerogels according to the present invention can also be used in construction materials due to their lightweight, strength, ability to be formed into desired shapes and superior thermal insulation properties.

Polysiloxane based aerogels according to the present invention can be also used for storage of cryogens.

Polysiloxane based aerogels according to the present invention can be also used as an adsorption agent for oil spill clean-up, due to their high oil absorption rate.

Polysiloxane based aerogels according to the present invention can be also used in safety and protective equipment as a shock-absorbing medium.

### EXAMPLES

### Example 1

Aerogel was prepared by using a hydroxyl-terminated PDMS monomer (PDMS-OH), an aliphatic trifunctional isocyanate and triethylamine as a catalyst, and it was dried by super critical drying. Reaction is illustrated in scheme 2.

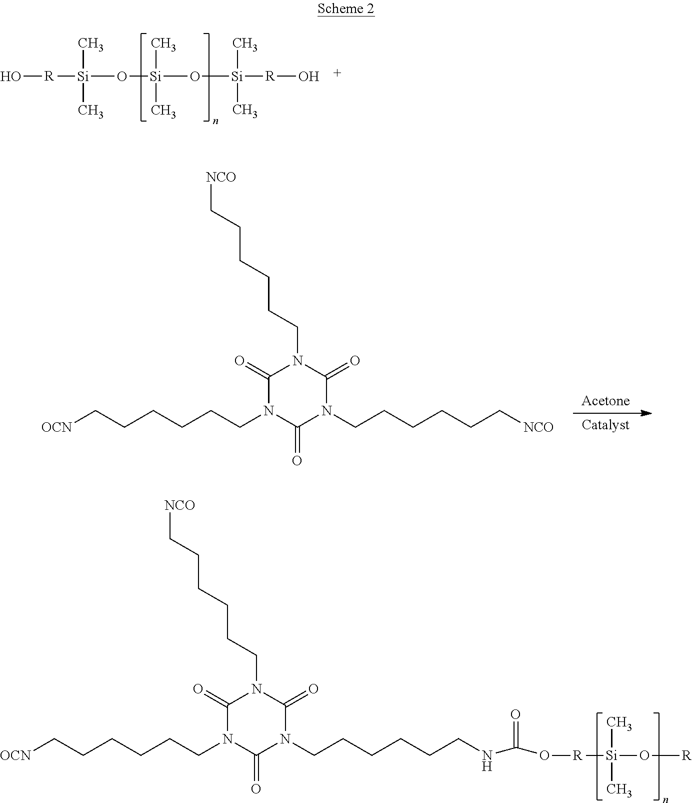

0.99 g of multi-functional isocyanate (Desmodur N3300) and 1.41 g of PDMS-OH (MW=550 g/mol) were weighted in a polypropylene cup. Subsequently, 30 mL of solvent (acetone) was poured into the cup and the solution was stirred until the precursors were completely dissolved. 0.48 g of triethylamine (TEA) was added, and the solution was mixed to obtain a homogeneous system. The final solution was left to gel in the same recipient. The samples were dried using supercritical conditions. For the aerogels prepared in acetone, the samples were washed for 24 h in fresh acetone three times, with the double amount of solvent used in the preparation of the gel. In the case of the samples were prepared in a different solvent, a solvent exchange procedure (to acetone) was performed as follows: 1) the solvent was exchanged to a mixture of the organic solvent used and acetone (1:0.25) in volume, respectively; 2) after 24 h, the mixture was replaced by the same mixture on a 1:1 ratio; 3) after 24 h, the solvent was replaced by the final mixture on a 0.25:1 ratio in volume; 4) the last washing step was done with a 100% of acetone. Finally, the samples were dried under supercritical conditions of CO₂.

| | Density | Thermal conductivity | Compression Young |
|---|---|---|---|
| Solvent | (g/cm³) | (mW/m · K) | Modulus (MPa) |
| Acetone | 0.048 | 30.8 | 0.1 |

Thermal conductivity was measured with the C-Therm TCi according to the method described above. Young modulus was measured with an Instron 3366 in compression test.

### Example 2

Aerogel was prepared by using an epoxy-terminated PDMS monomer and dimethylbenzylamine as a catalyst dried by a super critical drying. Reaction is illustrated in scheme 3.

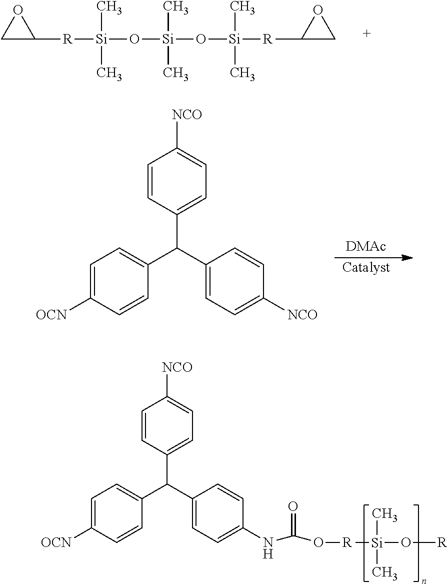

### Scheme 3

0.24 g of multi-functional isocyanate (Desmodur RE) and 6.26 g of PDMS-epoxy (MW=800 g/mol) were weighted in a polypropylene cup. Subsequently, 30 mL of dimethylacetamide (DMAc) was poured into the cup and the solution was stirred until the precursors were completely dissolved. 0.24 g of dimehtylbenzylamine were added, the solution was mixed to obtain a homogeneous system and the final solution was left to gel in the same recipient at 80° C. for 3 h. The drying procedure was identical to the one described in Example 1 for supercritical drying.

| | Density | Thermal conductivity |
|---|---|---|
| Solvent | (g/cm³) | (mW/m · K) |
| DMAc | 0.246 | 45 |

Thermal conductivity was measured with the C-Therm TCi according to the method described above.

### Example 3

Aerogel was prepared by using a hydroxyl-terminated PDMS monomer (PDMS-OH) and triethylamine as a catalyst and gel was dried by ambient drying.

The aerogel was prepared using the same procedure described in Example 1, with the exception that, in this case, the drying procedure was at room pressure and temperature (ambient drying). For that, a solvent exchange was performed with 60 mL of a mixture of the organic solvent used (acetone) and hexane (1:0.25) in volume, respectively. After 24 h, the mixture was replaced by the same composition on a 1:1 ratio. After 24 h, the solvent was replaced by the final mixture on a 0.25:1 ratio in volume. The last washing step was done with a 100% of hexane. Finally, the sample was left to dry at room conditions.

| | Density | Thermal conductivity |
|---|---|---|
| Solvent | (g/cm³) | (mW/m · K) |
| Acetone | 0.065 | 40 |

Thermal conductivity was measured with the C-Therm TCi according to the method described above.

### Example 4

Aerogel was prepared by using a hydroxyl-terminated PDMS monomer (PDMS-OH) and DBTDL as a catalyst and the gel was dried by SCD. The gel was prepared by using the same procedure described in Example 1, with the exception that, in this case, Desmodur RE was used as an isocyanate and dibutyltin dilaurate (DBTDL) was used as a catalyst.

3.32 g of isocyanate solution (Desmodur RE) and 2.02 g of PDMS-OH (MW=550 g/mol), ratio isocyanate/alcohol 1/1 were weighted in a polypropylene cup.

Subsequently, 19 mL of solvent (acetone) were poured in the cup and the solution was stirred until the precursors were completely dissolved. 0.24 g of DBTDL was added, the solution was mixed to obtain a homogeneous system. The final solution was left to gel in the same recipient. Initial solid content of the solution was 12 wt %. The drying procedure was identical to the one described in Example 1 for supercritical drying.

| | Density | Thermal conductivity |
|---|---|---|
| Solvent | (g/cm³) | (mW/m · K) |
| Acetone | 0.067 | 39 |

Thermal conductivity was measured with the C-Therm TCi according to the method described above.

### Example 5

Aerogel was prepared by using a hydroxyl terminated PDMS monomer (PDMS-OH) and DBTDL as a catalyst, reinforced with honeycomb and dried by SCD.

The gel was prepared using the same procedure described in Example 1, with the exception that, in this case, a honeycomb structure was used for mechanical reinforcement. To do that, after the addition of the catalyst, a honeycomb structure was incorporated before the gel formation, with the same volume corresponding to the volume of the solvent. The solution was left to gel and dried by supercritical drying, as described in Example 1.

| | Density | Thermal conductivity | Compression Young |
|---|---|---|---|
| Solvent | (g/cm³) | (mW/m · K) | Modulus (MPa) |
| Acetone | 0.082 | 39 | 63 |

Thermal conductivity was measured with the C-Therm TCi according to the method described above. Young modulus was measured with an Instron 3366 in compression test.

### Example 6

The aerogel was prepared by using a hydroxyl-terminated PDMS monomer (PDMS-OH) using the same procedure described in Example 1, but in this case a tetrafunctional isocyanate (Desmodur HR) was used and the NCO/OH equivalent ratio was 0.5.

2.34 g of multi-functional isocyanate (Desmodur HR) and 2.45 g of PDMS-OH (MW=550 g/mol) were weighted in a polypropylene cup. Subsequently, 24.4 mL of solvent (acetone) was poured into the cup and the solution was stirred until the precursors were completely dissolved. 0.72 g of triethylamine (TEA) was added, and the solution was mixed to obtain a homogeneous system. The final solution was left to gel in the same recipient. Once the gel was formed, the sample was washed for 3 times with fresh acetone. Finally, the samples were dried under supercritical conditions of CO₂.

| | Density | Thermal conductivity |
|---|---|---|
| Solvent | (g/cm³) | (mW/m · K) |
| Acetone | 0.082 | 42.4 |

Thermal conductivity was measured with the C-Therm TCi according to the method described above.

### Example 7

An aerogel was prepared by using an epoxycyclohexylethyl polydimethylsiloxane as monomer, with an epoxy functionality higher than 2 (formula 4). In this case, Desmodur RE was used as isocyanate, DMBA was chosen as catalyst and DMAc was selected as solvent. The gels were dried by supercritical drying as described above.

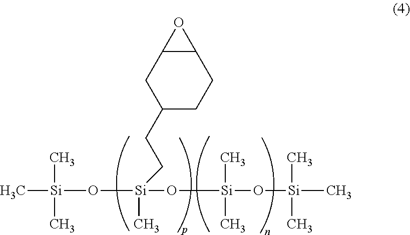

1.64 g of multi-functional isocyanate (Desmodur RE) and 2.0 g of PDMS-epoxy (MW=10000-12000 g/mol) were weighted in a polypropylene cup. Subsequently, 17.71 mL of dimethylacetamide (DMAc) was poured into the cup and the solution was stirred until the precursors were completely dissolved. 0.55 g of dimehtylbenzylamine were added, the solution was mixed to obtain a homogeneous system and the final solution was left to gel in the same recipient at 80° C. overnight. The drying procedure was identical to the one described in Example 1 for supercritical drying.

| | Density | Thermal conductivity |
|---|---|---|
| Solvent | (g/cm³) | (mW/m · K) |
| DMAc | 0.229 | 40.7 |

Thermal conductivity was measured with the C-Therm TCi according to the method described above.

### Example 8

An aerogel was prepared using an epoxy-terminated PDMS, as described on Example 2. In this case, an aliphatic isocyanate was used as crosslinker and the NCO/epoxy equivalent ratio was equal to 5.

For the synthesis, 1.86 g of multi-functional isocyanate (Desmodur N3300) and 0.35 g of epoxypropoxypropyl terminated PDMS (MW=363 g/mol) were weighted in a polypropylene cup. Subsequently, 20.82 mL of dimethylacetamide (DMAc) was poured into the cup and the solution was stirred until the precursors were completely dissolved. 0.33 g of dimethylbenzylamine were added, the solution was mixed to obtain a homogeneous system and the final solution was left to gel in the same recipient at 80° C. overnight. The drying procedure was identical to the one described in Example 1 for supercritical drying.

| | Density | Thermal conductivity |
|---|---|---|
| Solvent | (g/cm³) | (mW/m · K) |
| DMAc | 0.499 | 51.8 |

Thermal conductivity was measured with the C-Therm TCi according to the method described above.

### Example 9

An aerogel was prepared using an amino-terminated PDMS monomer, acetone as solvent and triethylamine as a catalyst, and was dried by a super critical drying. Reaction is illustrated in Scheme 5.

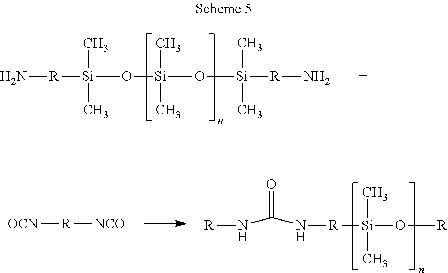

0.77 g of multi-functional isocyanate (Desmodur N3300) and 0.50 g of bis(aminopropyl terminated)-PDMS (MW=2500 g/mol) were weighted in a polypropylene cup. Subsequently, 14.3 mL of acetone was poured into the cup and the solution was stirred until the precursors were completely dissolved. 0.13 g of triethylamine were added, the solution was mixed to obtain a homogeneous system and the final solution was left to gel in the same recipient at room conditions. The drying procedure was identical to the one described in Example 1 for supercritical drying.

| | Density | Thermal conductivity |
|---|---|---|
| Solvent | (g/cm³) | (mW/m · K) |
| Acetone | 0.193 | 34.5 |

Thermal conductivity was measured with the C-Therm TCi according to the method described above.

### Example 10

An aerogel was prepared using an amino-terminated PDMS monomer, acetone as solvent and triethylamine as a catalyst, and was dried by a super critical drying. The NCO/NH₂ equivalent ratio was equal to 3.

For the synthesis, 1.34 g of an aromatic multi-functional isocyanate (Desmodur RE) and 0.70 g of bis(aminopropyl terminated)-PDMS (MW=875 g/mol) were weighted in a polypropylene cup. Subsequently, 14.0 mL of acetone was poured into the cup and the solution was stirred until the precursors were completely dissolved. 0.26 g of triethylamine were added, the solution was mixed to obtain a homogeneous system and the final solution was left to gel in the same recipient at room conditions. The drying procedure was identical to the one described in Example 1 for supercritical drying.

| | Density | Thermal conductivity |
|---|---|---|
| Solvent | (g/cm³) | (mW/m · K) |
| Acetone | 0.327 | 50.0 |

Thermal conductivity was measured with the C-Therm TCi according to the method described above.

### Example 11

An aerogel was prepared as described on Example 1. In this case, bis (hydroxyalkylterminated)-PDMS was used as monomer. An aliphatic trifunctional isocyanate was used as crosslinker and triethylamine as a catalyst. The sample was dried by super critical drying.

For the preparation, 1.19 g of multi-functional isocyanate (Desmodur N3300) and 1.50 g of PDMS-C-OH (MW=600-850 g/mol) were weighted in a polypropylene cup. Subsequently, 18.98 mL of solvent (acetone) was poured into the cup and the solution was stirred until the precursors were completely dissolved. 0.27 g of triethylamine (TEA) was added, and the solution was mixed to obtain a homogeneous system. The final solution was left to gel in the same recipient.

| | Density | Thermal conductivity |
|---|---|---|
| Solvent | (g/cm³) | (mW/m · K) |
| Acetone | 0.134 | 43.3 |

Thermal conductivity was measured with the C-Therm TCi according to the method described above

### Example 12

An aerogel was prepared by using an epoxycyclohexylethyl terminated polydimethylsiloxane as monomer (formula 17). In this case, Desmodur RE was used as isocyanate, DMBA was chosen as catalyst and DMAc was selected as solvent. The gels were dried by supercritical drying as described above.

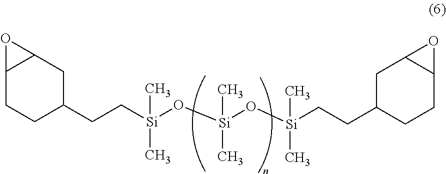

1.35 g of multi-functional isocyanate (Desmodur RE) and 1.0 g of PDMS-epoxy (MW=669 g/mol) were weighted in a polypropylene cup. Subsequently, 17.15 g of dimethylacetamide (DMAc) was poured into the cup and the solution was stirred until the precursors were completely dissolved. 0.35 g of dimehtylbenzylamine were added, the solution was mixed to obtain a homogeneous system and the final solution was left to gel in the same recipient at 80° C. overnight. The drying procedure was identical to the one described in Example 1 for supercritical drying.

| | Density | Thermal conductivity |
|---|---|---|
| Solvent | (g/cm³) | (mW/m · K) |
| DMAc | 0.221 | 39.1 |

Thermal conductivity was measured with the C-Therm TCi according to the method described above.

### Example 13

An aerogel was prepared by using a mixture of epoxycyclohexylethyl terminated polydimethylsiloxane and bis(aminopropyl terminated)-PDMS as monomers. Desmodur RE was used as isocyanate, DMBA was chosen as catalyst and DMAc was selected as solvent. The gels were dried by supercritical drying as described above.

For the synthesis, 0.3 g of PDMS-epoxy (MW=370 g/mol) and 0.3 g of bis(aminopropyl terminated)-PDMS (MW=2500 g/mol) were weighted in a polypropylene cup. Subsequently, 14.31 g of dimethylacetamide (DMAc) was poured into the cup and 1.46 g of multi-functional isocyanate (Desmodur RE) was added. Finally, 0.31 g of dimehtylbenzylamine were added to the mixture and the solution was mixed to obtain a homogeneous system. The final solution was left to gel in the same recipient at 80° C. overnight. The drying procedure was identical to the one described in Example 1 for supercritical drying.

| | Density | Thermal conductivity |
|---|---|---|
| Solvent | (g/cm³) | (mW/m · K) |
| DMAc | 0.194 | 37.8 |

Thermal conductivity was measured with the C-Therm TCi according to the method described above.

Polysiloxane based aerogels obtained by reacting mixtures of different functionalised poly(dimethylsiloxane) oligomers and an aliphatic or aromatic isocyanate compound may lead to improvement in hydrophobic properties of the aerogel.

Polysiloxane aerogels according to the present invention show densities in the range of 0.02 to 0.6 g/cm³ and a compression moduli from 0.01 MPa up to 60 MPa. Thermal conductivity of the polysiloxane aerogels can be measured by means of a diffusivity method. Polysiloxane aerogels show thermal conductivity coefficients in the range of 30 up to 60 mW/mK.

What is claimed is:

1. A polysiloxane based aerogel obtained by reacting a functionalised poly(dimethylsiloxane) oligomer and an aliphatic or aromatic isocyanate compound in a presence of a catalyst and a solvent, wherein said functionalised poly(dimethylsiloxane) oligomer is selected from the group consisting of 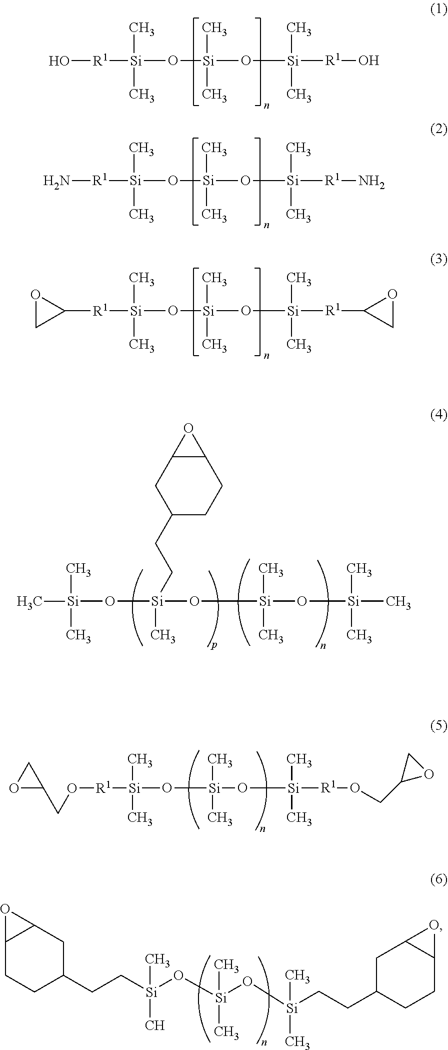
wherein R¹ is selected from the group consisting of CₘH₂ₘ m alkyl or aryl group, where m is from 0 to 10, and n is an integer from 0 to 200, and p is an integer from 1 to 20.

2. A polysiloxane based aerogel according to claim 1, wherein said functionalised poly(dimethylsiloxane) oligomer is selected from the group consisting of silanol terminated polydimethylsiloxanes, aminopropyl terminated polydimethylsiloxanes, N-ethylaminoisobutyl terminated polydimethylsiloxane, epoxypropoxypropyl terminated polydimethylsiloxanes, (epoxypropoxypropyl)dimethoxysilylterminated polydimethylsiloxanes, epoxycyclohexylethyl terminated polydimethylsiloxanes, carbinol (hydroxyl) terminated polydimethylsiloxanes and mixtures thereof.

3. A polysiloxane based aerogel according to claim 1, wherein said aliphatic or aromatic isocyanate compound is selected from the group consisting of 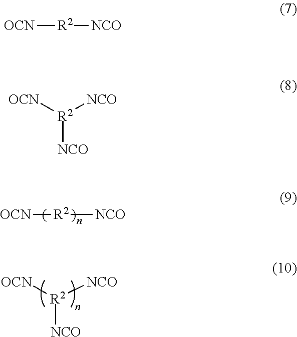
wherein R² is selected from the group consisting of a single bonded —O—, —S—, —C(O)—, S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof; and n is an integer from 1 to 30; 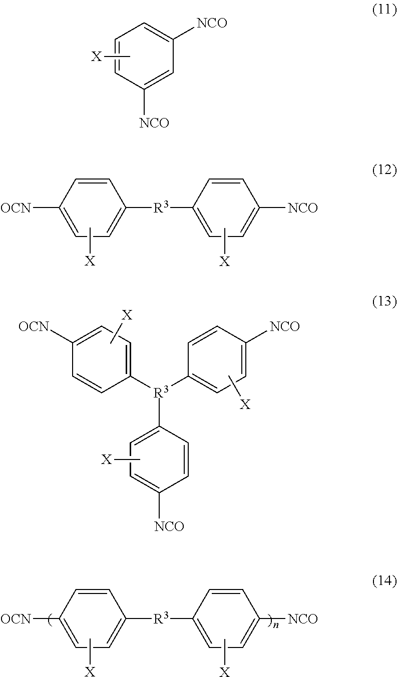
wherein X represents a substituent, or different substituents and are selected independently from the group consisting of hydrogen, halogen and linear or branched C1-C6 alkyl groups, attached on their respective phenyl ring at the 2-position, 3-position or 4-position, and their respective isomers, and R³ is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3 to C30 heterocycloalkyl group and a substituted or unsubstituted C1-C30 heteroalkyl group from and a combination of thereof; and n is an integer from 1 to 30; 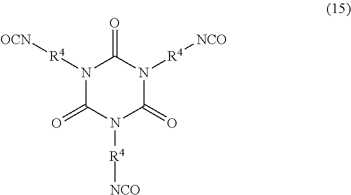
wherein R⁴ is alkyl group having 1-10 carbon atoms; 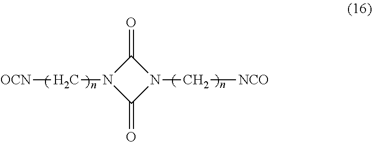
wherein n is an integer having a mean value from 2 to 18; 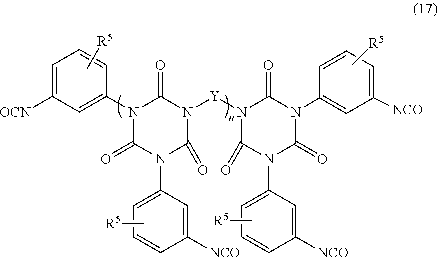
wherein R⁵ is selected independently from the group consisting of alkyl, hydrogen and alkenyl, and Y is selected from the group consisting of 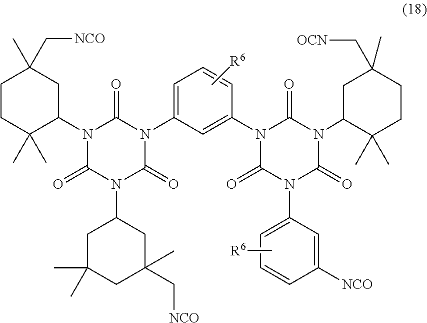
and n is an integer from 0 to 3; 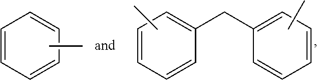
wherein R⁶ is selected independently from the group consisting of alkyl, hydrogen and alkenyl, preferably isocyanate compound is selected from the group consisting of 1,3,5-tris(6-isocyanatohexyl)-1,3,5-triazinane-2,4,6-trione, 6-[3-(6-isocyanatohexyl)-2,4-dioxo-1,3-diazetidin-1-yl]hexyl N-(6-isocyanatohexyl)carbamate, methylene diphenyl diisocyanate (MDI), 1-[bis(4-isocyanatophenyl)methyl]-4-isocyanatobenzene, 2,4-diisocyanato-1-methyl-benzene, oligomers of 1,3,5-tris(6-isocyanatohexyl)-1,3,5-triazinane-2,4,6-trione, oligomers of 6-[3-(6-isocyanatohexyl)-2,4-dioxo-1,3-diazetidin-1-yl]hexyl N-(6-isocyanatohexyl)carbamate, oligomers of methylene diphenyl diisocyanate (MDI), oligomers of 1-[bis(4-isocyanatophenyl)methyl]-4-isocyanatobenzene, oligomers of 2,4-diisocyanato-1-methyl-benzene and mixtures thereof.

4. A polysiloxane based aerogel according to claim 1, wherein said solvent is a polar aprotic or non-polar solvent, preferably polar aprotic solvent, more preferably a solvent selected from the group consisting of acetone dimethylsulfoxide, dimethylformamide, dimethylacetamide, N-methyl-2-pyrrolidone, 1,4-dioxane, acetonitrile, methyl ethyl ketone, methyl isobutyl ketone, toluene and mixtures thereof.

5. A polysiloxane based aerogel according to claim 1, wherein said catalyst is selected from the group consisting of alkyl amines, aromatic amines, imidazole derivatives, tin derivatives, aza compounds, guanidine derivatives, amidines and mixtures thereof.

6. A polysiloxane based aerogel according to claim 1, wherein said aerogel has a solid content from 2.5 to 50% by weight of the initial solution weight, preferably from 3 to 30% and more preferably from 5 to 15%.

7. A polysiloxane based aerogel according to claim 1, wherein functionalised poly(dimethylsiloxane) oligomer content is from 1 to 40% by weight of the initial solution weight, preferably from 2 to 30% and more preferably from 3 to 25%.

8. A polysiloxane based aerogel according to claim 1, wherein isocyanate compound content is from 0.5 to 30% by weight of the initial solution weight, preferably from 0.5 to 20% and more preferably from 0.5 to 10%.

9. A polysiloxane based aerogel according to claim 1, wherein a functionalised poly(dimethylsiloxane) oligomer and an aliphatic or aromatic isocyanate compound equivalent ratio is NCO/OH≥0.5, preferably NCO/OH÷1, when hydroxyl functionalised poly(dimethylsiloxane) oligomer is used; NCO/NH₂≥1 when amino functionalised poly(dimethylsiloxane) oligomer is used; and NCO/epoxy≥0.3, preferably NCO/epoxy from 3:1 to 1:3 when epoxy functionalised poly(dimethylsiloxane) oligomer is used.

10. A polysiloxane based aerogel according to claim 1, wherein said aerogel further comprises at least one reinforcement, wherein said reinforcement is selected from the group consisting of fibres, particles, non-woven and woven fibre fabrics, 3D structures and mixtures thereof.

11. A polysiloxane based aerogel according to claim 1, wherein said aerogel has a thermal conductivity less than 60 mW/m·K, preferably less than 50 mW/m·K, more preferably less than 45 mW/m·K measured by C-Therm TCi means.

12. A process for preparing a polysiloxane based aerogel according to claim 1 comprising the steps of:
1) dissolving poly(dimethylsiloxane) oligomer and an isocyanate compound into a solvent and mixing;
2) adding a catalyst and mixing;
3) letting the mixture of step 2 stand to form a gel;
4) washing the gel of step 3 with a solvent;
5) drying the gel of step 4 by supercritical or ambient drying.

13. A process according to claim 12, wherein temperature from 20° C. to 100° C. is applied at step 3 to form a gel, preferably temperature from 20° C. to 75° C. is applied, and more preferably, temperature from 20° C. to 50° C. is applied.

14. A thermal or an acoustic insulating material comprising a polysiloxane based aerogel according to claim 1.
